(19) United States
(12) Patent Application Publication
(10) Pub. No.: US 2012/0039664 A1
(43) Pub. Date: Feb. 16, 2012

(54) BINDER HAVING STRUCTURE FOR PUNCHING DOCUMENT

(76) Inventor: Chung-Real Lee, Gyeonggi-do (KR)

(21) Appl. No.: 13/266,684

(22) PCT Filed: Apr. 27, 2010
(86) PCT No.: PCT/KR10/02653

§ 371 Date: Oct. 27, 2011

(30) Foreign Application Priority Data
Apr. 27, 2009 (KR) 10-2009-0036741

(51) Int. Cl. B42F 13/40

(52) U.S. Cl. 402/1

(57) ABSTRACT

Disclosed is a binder having a punching structure. The binder includes: a binder body which receives media therein and includes a cover part, a media binding part, and a central part which is formed to be bent with a predetermined width between the cover part and the media binding part; a fixing holder which is formed in the media binding part and binds the media; and a puncher which is positioned in the inside of the central part in such a manner that the puncher does not interfere in the media bound to the fixing holder, and punches filing holes in the media.

### TECHNICAL FIELD

Apparatuses consistent with the exemplary embodiments relate to a binder for binding documents and so on, and more particularly, to a binder having a structure for punching documents.

### BACKGROUND ART

In general, a binder is one type of office supplies and is used to bind documents or photo albums.

A typical binder includes a cover and a filing device which is provided within the cover for binding documents. The filing device has a hinged structure and includes a plurality of fixing rings formed with an interval. While such a configured binder has to punch filing holes in targeted documents or papers to bind the documents or papers, the typical binder has no punch structure. Therefore, a separate puncher has to be used to punch the documents or the paper, which may result in cumbersomeness in using the binder.

### DISCLOSURE

### Technical Problem

To solve the above technical problems, one or more exemplary embodiments of the present invention provide a binder having a structure for punching filing holes in documents or papers.

Another exemplary embodiment is to provide a binder having a document punching structure optimally arranged to prevent documents to be bound from interfering in the document punching structure.

### Technical Solution

The foregoing and/or other aspects may be achieved by providing a binder having a punching structure, including: a binder body which receives media therein and includes a cover part, a media binding part, and a central part which is formed to be bent with a predetermined width between the cover part and the media binding part; a fixing holder which is formed in the media binding part and binds the media; and a puncher which is positioned in the inside of the central part in such a manner that the puncher does not interfere in the media bound to the fixing holder, and punches filing holes in the media.

The puncher may includes: a punching base which is combined to the central part and has a cutter hole formed thereon; a lever member which is hinged to the punching base; a cutter which is formed in one side of the lever member at a position opposing the cutter hole of the punching base and punches the filing holes in the media; and an elastic member which elastically biases the lever member in one direction.

The puncher may includes: a punching base which is combined to the central part and has a cutter hole formed thereon; a lever member which is hinged to the punching base; a cutter holder which is provided to be isolated by a gap from the cutter hole of the punching base and has a cutter through hole formed at a position opposing the cutter hole of the punching base; a cutter which is provided to be elevatable in the cutter though hole and punches the filing holes in the media by virtue of a pressurizing force of the lever member; and an elastic member which elastically biases the cutter toward the lever member.

The cutter may include: a cutter body which is provided to be elevatable in the cutter through hole; and a cutter head which is formed in an end portion of the cutter body at the side of the lever member, and the elastic member may be interposed between the punching base.

The puncher may further include a stopper which projects from the punching base and restricts insertion depth of the media introduced between the punching base and the lever member.

A media fixing position of the fixing holder and a formation position of the cutter may have the same height in the binder body so as to punch new media to be bound in alignment with the media fixed by the fixing holder.

The puncher may further include a receiving member which is detachably combined to the bottom of the punching base and receives punching residues discharged via the cutter hole when the media are punched.

The fixing holder may include: a holder base which is formed in the media binding part; a filing device which is provided to be opened/closed in the holder base and is inserted in the filing holes of the media; and a handle member which is provided in the holder base and regulates the open/close of the filing device.

### Advantageous Effects

According to an embodiment, since the binder having the punching structure is integrally formed with the puncher which punches the filing holes in the media, it is possible to avoid cumbersomeness such as providing a separate puncher to punch media to be bound.

According to an embodiment, since the puncher is arranged in the central part of the binder body and the fixing holder is arranged in the media binding part such that the puncher does not interfere in the media bound to the fixing holder, it is possible to prevent the media from being damaged by the puncher.

According to an embodiment, since the puncher is formed with a simple structure including the punching base, the lever member, the cutter and the elastic member, it is possible to minimize increase in production costs even if the punching structure is implemented in the binder.

### DESCRIPTION OF DRAWINGS

FIG. 1 is a perspective view showing a binder according to an exemplary embodiment of the present invention.

FIG. 2 is a side view showing the binder according to the exemplary embodiment.

FIG. 3 is a perspective view showing a fixing holder of the binder according to the exemplary embodiment of the present invention.

FIG. 4 is an exploded perspective view showing a first embodiment of a puncher of the binder according to the exemplary embodiment.

FIG. 5 is a sectional view showing the first embodiment of the puncher of the binder according to the exemplary embodiment.

FIG. 6 is a sectional view showing a second embodiment of the puncher of the binder according to the exemplary embodiment.

FIG. 7 is an exploded perspective view showing a third embodiment of the puncher of the binder according to the exemplary embodiment.

FIGS. 8 and 9 are sectional views showing the third embodiment of the puncher of the binder according to the exemplary embodiment.

### MODE FOR INVENTION

Below, binders having a punching structure according to exemplary embodiments of the present invention will be described in detail with reference to the accompanying drawings.

In the following description and the attached claims, media received in a binder are intended to encompass all types of media formed with filing holes, including documents, papers, albums and the like.

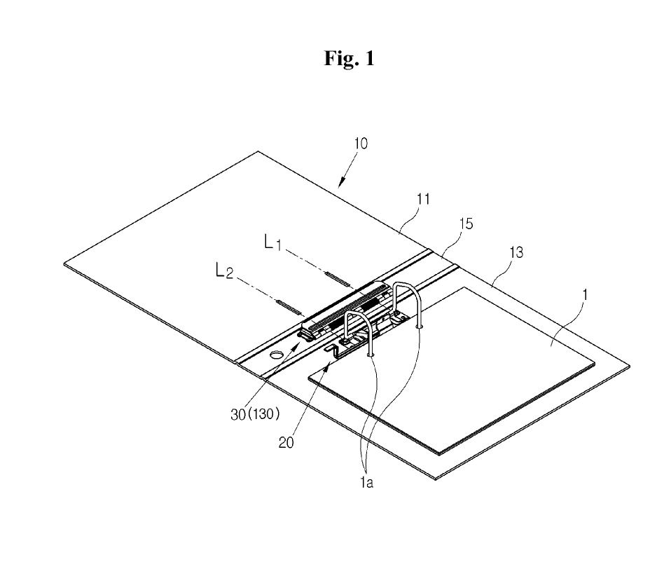

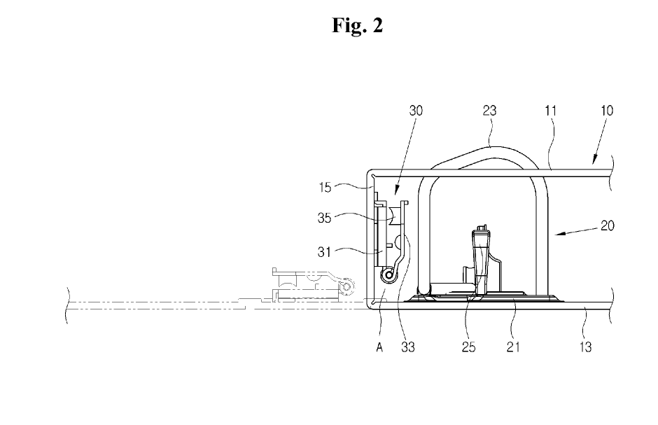

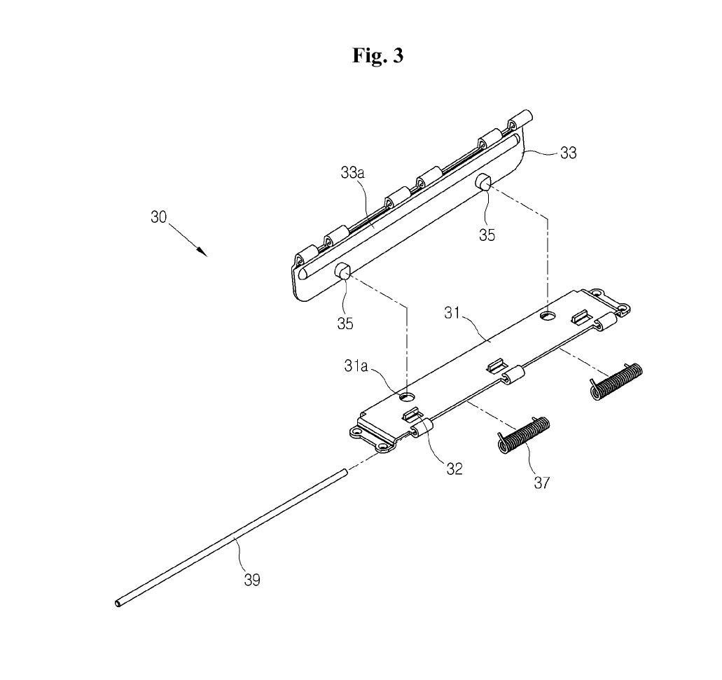

FIGS. 1 and 2 are a perspective view and a side view showing a binder according to an exemplary embodiment of the present invention, respectively, and FIG. 3 is a perspective view showing a fixing holder of the binder according to the exemplary embodiment of the present invention.

Referring to these figures, a binder according to an exemplary embodiment of the present invention includes a binder body 10 which receives media 1 having filing holes la punched therein, and a fixing holder 20 and a puncher 30 (130) which are formed in the binder body 10. In this embodiment, the filing holes 1a may be formed in various ways, including a two-hole way, a three-hole way and the like, depending on the type of binder.

The binder body 10 includes a cover part 11, a media binding part 13, and a central part 15 which is formed to be bent with a predetermined width between the cover part 11 and the media binding part 13. The central part 15 corresponds to a portion forming a binder width when the binder is folded, with the binder indexed in the outside of the central part 15.

The fixing holder 20 is formed in the media binding part 13 and binds the media 1 through the filing holes 1a of the media 1.

Referring to FIGS. 2 and 3, the fixing holder 20 includes a holder base 21 formed in the media binding part 13, a filing device 23 having one openable end portion provided in the holder base 21, and a handle member 25 which regulates the open of the filing device 23. The filing device 23 is hinged to the holder base 21. The filing device 23 may be elastically biased by an elastic piece provided in the holder base 21 in a direction regulated by the handle member 25. Accordingly, when a pressurizing force by the handle member 25 is released, the filing device 23 can be rotated in a direction in which its end portion is opened.

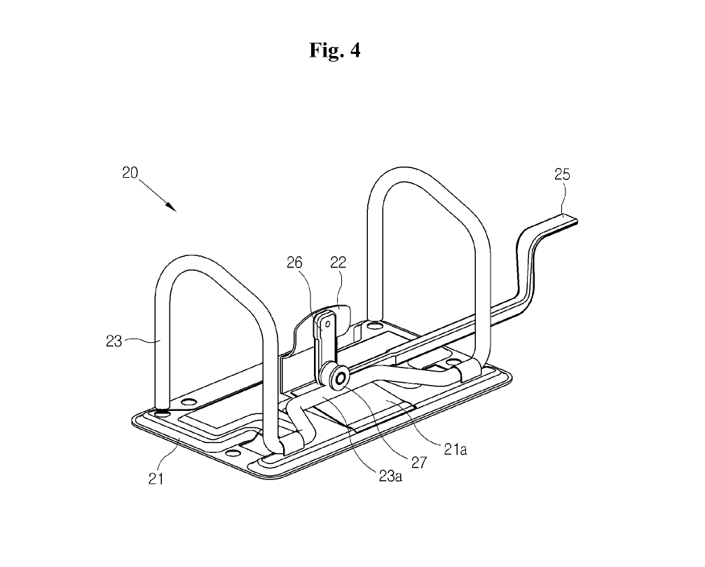

The handle member 25 may include a rotating part 26 which is provided to be rotated with respect to a projecting piece 22 provided in the holder base 21, and a rolling part 27 which rollably contacts one region 23a of the filing device 23, as shown in FIG. 4.

Accordingly, referring to FIG. 3, when an end portion of the handle member 25 is lifted, the rotating part 26 is counterclockwise rotated to release the pressurizing force exerted on the filing device 23. In this condition, the filing device 23 is rotated by the elastic piece 21a such that the end portion of the filing device 23 is opened. Under this condition, the filing device 23 is inserted in the filing holes 1a of the media 1.

Then, by closing the end portion of the filing device 23 and pressing the handle member 25 to rotate the rotating part clockwise, the rolling part 27 presses the filing device 23 such that the filing device 23 remains closed.

When the binder is folded, between the fixing holder 20 and the central part 15 is formed a space A in which the puncher 30 (130) is positioned. That is, the puncher 30 (130) is positioned in the inside of the central part 15 of the binder body 10 in such a manner that the puncher 30 (130) does not interfere in the media 1 bound to the fixing holder 20, and punches the filing holes 1a in the media 1.

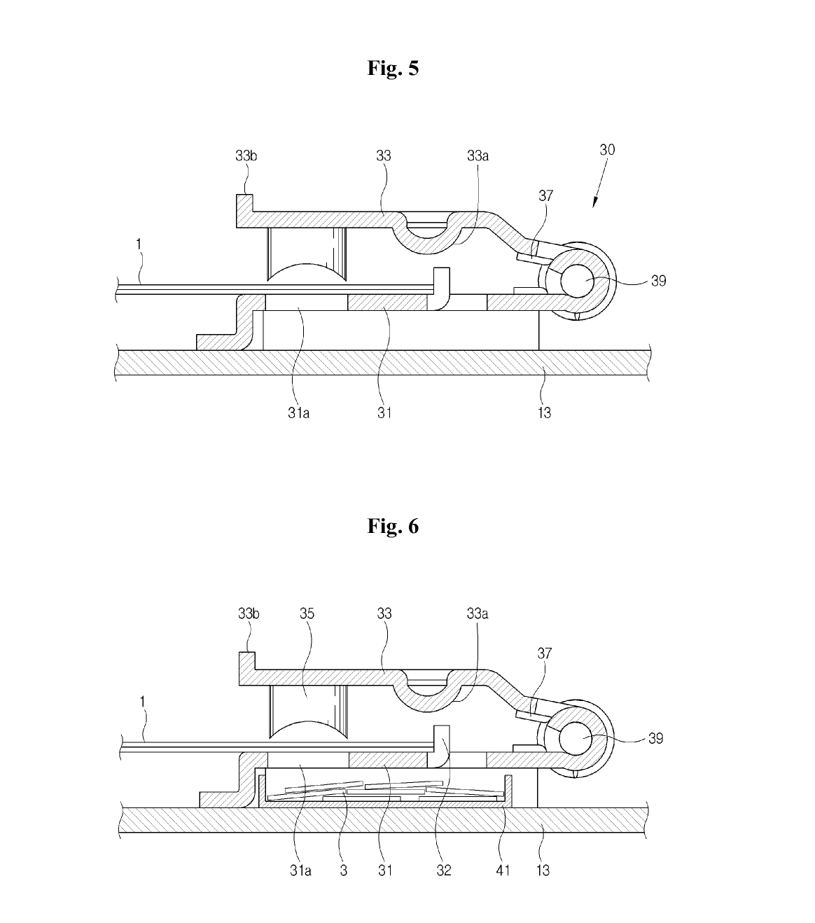

Referring to FIGS. 4 and 5, according to a first embodiment, the puncher 30 includes a punching base 31 which is combined to the central part 15 of the binder body 10 and has a cutter hole 31a formed thereon, a lever member 33 which is rotatably combined to the punching base 31, a cutter 35 which punches the media 1, and an elastic member 37.

The lever member 33 is rotatably hinged to the punching base 31. That is, the lever member 33 can be rotatably combined to the punching base 31 through a shaft 39. The lever member 33 may include a reinforcing part 33a which is bent to reinforce the strength of the lever member, and a handle part 33b which is formed in an end portion of the lever member to facilitate rotation manipulation by a user.

The cutter 35 is formed in one side of the lever member 33 at a position opposing the cutter hole 31a. The cutter 35 punches the filing holes in the media 1 inserted on the punching base 31 while interlocking with the lever member 33 and going in and out of the cutter hole 31a. The number of cutter holes 31a and the number of cutters 35 may depend on the number of filing devices of the binder to which the puncher 30 is applied. For example, the numbers of filing devices 23, cutter holes 31a and cutters 35 may be 3, respectively, for a binder for binding 3-hole media. The numbers of cutter holes 31a and cutters 35 of the puncher 30 are not limited thereto but may be modified in various ways. For example, a puncher for punching one filing hole at a time may be applied to a 3-hole binder.

The elastic member 37 elastically biases the lever member 33 in one direction. That is, the elastic member 37 provides an elastic force to restore the lever member 33 to a position in which the media can be inserted on the punching base 31 after the filing holes 1a are punched in the media 1 by the rotation of the lever member 33.

The puncher 30 may further include a stopper 32 projecting from the punching base 31. The stopper 32 restricts insertion depth of the media 1 introduced between the punching base 31 and the lever member 33 such that the filing holes are formed at a predetermined position in the depth direction.

In this invention, in forming the puncher in the binder body, a media fixing position of the fixing holder 20 and a formation position of the cutter 35 may have the same height in the binder body. More specifically, referring to FIG. 1, assuming that two filing devices 23 of the fixing holder 20 are formed and lines horizontally extending from the two filing devices 23 are L1 and L2, respectively, the puncher 30 is provided in the central part 15 of the binder body 10 such that the cutter 35 is located on the lines L1 and L2. By providing the fixing holder 20 and the puncher 30 in this manner, it is possible to punch new media to be bound in alignment with the media fixed by the fixing holder 20.

Hereinafter, an operation of punching the filing holes 1a in the media 1 using the above-configured puncher 30 will be described.

Referring to FIG. 5, the puncher 30 has its one side opened by the elastic member 37 under no application of an external force. In this state, one or more media 1 to be punched are inserted on the punching base 31. The insertion depth of the inserted media 1 is restricted by the stopper 32.

When the lever member 33 is pressed toward the punching base 31, the lever member 33 is rotated around the shaft 39 to descend the cutter 35. The descended cutter 35 punches the media 1 as it penetrates through the media 1 and is inserted in the cutter hole 31a. Thereafter, when the pressurizing force exerted on the lever member 33 is released, the lever member 33 is rotated by resilience of the elastic member 37 and accordingly the cutter 35 is ascended to open the one side of the puncher 30 again. The above-described operation is repeated to punch the media 1.

Referring to FIG. 6, in comparison with the puncher 30 according to the first embodiment, a puncher according to a second embodiment may further include a receiving member 41 which receives punching residues 3. The receiving member 41 is detachably combined to the bottom of the punching base 31. The receiving member 41 receives the punching residues 3 discharged via the cutter hole 31a when the media 1 are punched, thereby facilitating collection of the punching residues 3.

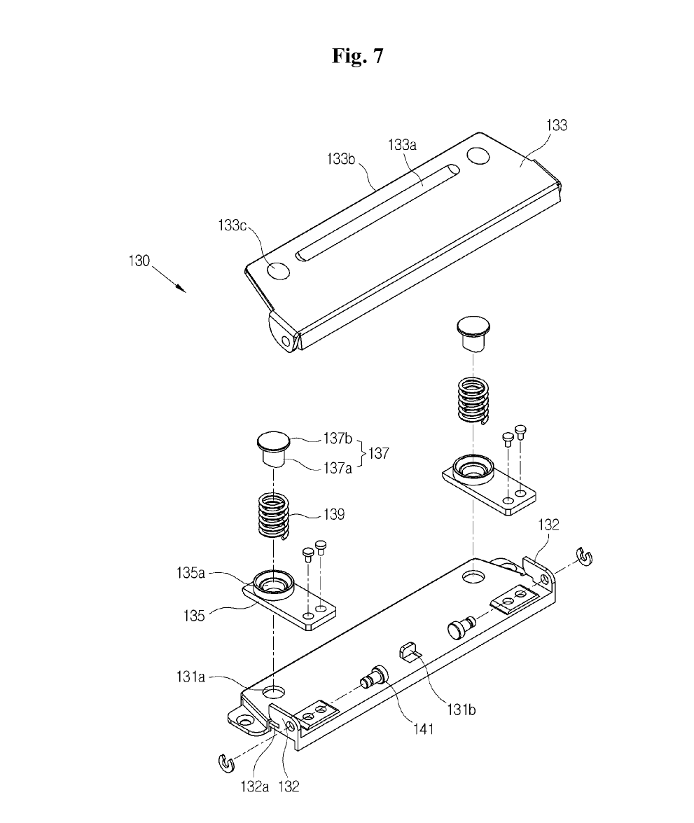

Referring to FIGS. 7 to 9, according to a third embodiment, a puncher 130 includes a punching base 131 which is combined to a central part (15 in FIG. 1) of a binder body and has a cutter hole 131a formed thereon, a lever member 133 which is rotatably combined to the punching base 31, a cutter holder 135, a cutter 137 which punches media 1, and an elastic member 139.

The lever member 133 is rotatably hinged to the punching base 131. That is, the lever member 33 can be rotatably combined to a bracket 132 formed in the punching base 131 through a rotation pin 141.

The lever member 133 may include a reinforcing part 133a which is bent to reinforce the strength of the lever member, a handle part 33b which is formed in an end portion of the lever member to facilitate rotation manipulation by a user, and a pressing part 133c which presses the cutter 137.

The cutter holder 135 is provided to be isolated by a gap from the cutter hole 131a of the punching base 131. A cutter through hole 135a is formed in the cutter holder 135 at a position opposing the cutter hole 131a of the punching base 131.

The cutter 137 is provided to be elevatable in the cutter though hole 135a. The cutter 137 punches filing holes in the media 1 inserted on the punching base 31 while going in and out of the cutter hole 131a by virtue of a pressurizing force of the lever member 133. To this end, the cutter 137 includes a cutter body 137a which is provided to be elevatable in the cutter through hole 135a, and a cutter head 137b formed in one end portion of the cutter body 137a. The cutter head 137b contacts the pressing part 133c formed in an end portion of the lever member 133 such that the cutter body 137a is ascended. The elastic member 139 is interposed between the punching base 131 and the cutter head 137b and the cutter body 137a is inserted into the elastic member 139.

The number of cutter holes 131a and the number of cutters 135 may depend on the number of filing devices of the binder to which the puncher 130 is applied. For example, as shown in FIG. 1, the numbers of cutter holes 131a and cutters 135 may be 2, respectively, for a binder for binding 2-hole media. The numbers of cutter holes 131a and cutters 135 of the puncher 130 are not limited thereto but may be modified in various ways.

The puncher 130 may further include a stopper 131b projecting from the punching base 131. The stopper 131b restricts insertion depth of the media 1 introduced between the punching base 131 and the lever member 133 such that the filing holes are formed at a predetermined position in the depth direction. In this embodiment, the puncher 130 may have a stopper groove 132b formed in the bracket 132, independent of the stopper 131b.

In this invention, in forming the puncher in the binder body, a media fixing position of the fixing holder (20 in FIG. 1) and a formation position of the cutter 137 may have the same height in the binder body.

Hereinafter, an operation of punching the filing holes 1a in the media 1 using the above-configured puncher 130 will be described.

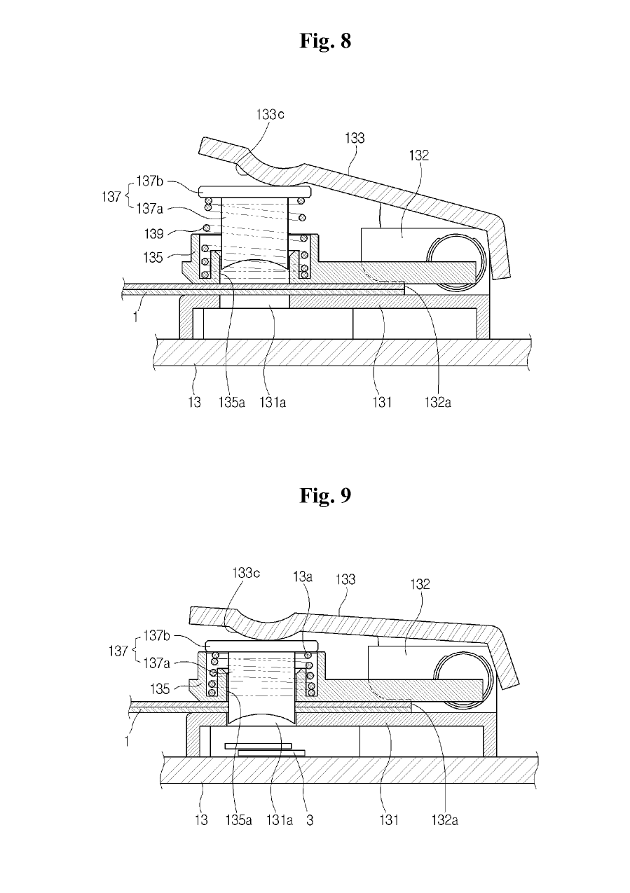

Referring to FIG. 8, the puncher 130 has its one side opened by the elastic member 139 under no application of an external force. In this state, one or more media 1 to be punched are inserted on the punching base 131. The insertion depth of the inserted media 1 is restricted by the stopper 131b and the stopper groove 132b of the bracket 132.

When the lever member 133 is pressed toward the punching base 131, the lever member 133 is rotated around the shaft 39 to descend the cutter 137, as shown in FIG. 9. The descended cutter 137 punches the media 1 as it penetrates through the media 1 and is inserted in the cutter hole 131a. Thereafter, when the pressurizing force exerted on the lever member 133 is released, the lever member 133 is rotated by resilience of the elastic member 139 and accordingly the cutter 137 is ascended to open the one side of the puncher 130 again. The above-described operation is repeated to punch the media 1. In this embodiment, the puncher 130 may further include a receiving member (not shown) which receives punching residues 31.

Although a few exemplary embodiments have been shown and described, it will be appreciated by those skilled in the art that changes may be made in these exemplary embodiments without departing from the principles and spirit of the invention, the scope of which is defined in the appended claims and their equivalents.

1. A binder having a punching structure, comprising:
a binder body which receives media therein and includes a cover part, a media binding part, and a central part which is formed to be bent with a predetermined width between the cover part and the media binding part;
a fixing holder which is formed in the media binding part and binds the media; and
a puncher which is positioned in the inside of the central part in such a manner that the puncher does not interfere in the media bound to the fixing holder, and punches filing holes in the media.

2. The binder according to claim 1, wherein the puncher includes:
a punching base which is combined to the central part and has a cutter hole formed thereon;
a lever member which is hinged to the punching base;
a cutter which is formed in one side of the lever member at a position opposing the cutter hole of the punching base and punches the filing holes in the media; and
an elastic member which elastically biases the lever member in one direction.

3. The binder according to claim 1, wherein the puncher includes:
a punching base which is combined to the central part and has a cutter hole formed thereon;
a lever member which is hinged to the punching base;
a cutter holder which is provided to be isolated by a gap from the cutter hole of the punching base and has a cutter through hole formed at a position opposing the cutter hole of the punching base;
a cutter which is provided to be elevatable in the cutter though hole and punches the filing holes in the media by virtue of a pressurizing force of the lever member; and
an elastic member which elastically biases the cutter toward the lever member.

4. The binder according to claim 3, wherein the cutter includes:
a cutter body which is provided to be elevatable in the cutter through hole; and
a cutter head which is formed in an end portion of the cutter body at the side of the lever member, and
wherein the elastic member is interposed between the punching base and the cutter head and the cutter body is inserted in the elastic member.

5. The binder according to claim 2, wherein the puncher further includes a stopper which projects from the punching base and restricts insertion depth of the media introduced between the punching base and the lever member.

6. The binder according to claim 2, wherein a media fixing position of the fixing holder and a formation position of the cutter have the same height in the binder body so as to punch new media to be bound in alignment with the media fixed by the fixing holder.

7. The binder according to claim 2, wherein the puncher further includes a receiving member which is detachably combined to the bottom of the punching base and receives punching residues discharged via the cutter hole when the media are punched.

8. The binder according to claim 1, wherein the fixing holder includes:
a holder base which is formed in the media binding part;
a filing device which is provided to be opened/closed in the holder base and is inserted in the filing holes of the media; and
a handle member which is provided in the holder base and regulates the open/close of the filing device.
